(19) United States
(12) Patent Application Publication
(10) Pub. No.: US 2024/0229257 A1
(43) Pub. Date: Jul. 11, 2024

(54) PHOTO-ELECTROCHEMICAL CELL AND CORRESPONDING APPARATUS

(71) Applicant: GREEN INDEPENDENCE S.R.L., Brindisi (IT)

(72) Inventor: Alessandro MONTICELLI, Brindisi (IT)

(21) Appl. No.: 18/561,418

(22) PCT Filed: May 16, 2022
(86) PCT No.: PCT/IB2022/054544

§ 371 Date: Nov. 16, 2023

(30) Foreign Application Priority Data
May 18, 2021 (IT) 102021000012830

(51) Int. Cl. C25B 9/50; C25B 9/65; C25B 9/70; C25B 11/032; C25B 11/087; C25B 15/025; C25B 15/08; H02S 40/30

(52) U.S. Cl. CPC C25B 9/50; C25B 9/65; C25B 9/70; C25B 11/032; C25B 11/087; C25B 15/025; C25B 15/083; C25B 15/087; H02S 40/30

(57) ABSTRACT

An electrochemical cell has a first reaction chamber having a first electrode, a second reaction chamber having a second electrode, a membrane-electrode assembly having an ion-exchange membrane, and a photovoltaic system for absorbing solar energy and producing an output voltage between a first output terminal selectively couplable to the first electrode and a second output terminal selectively couplable to the second electrode. The ratio between a photosensitive area of the photovoltaic system and an active area of the first and second electrodes is less than or equal to fifty. A plurality of photovoltaic cells is selectively couplable between the first and second output terminals. An electronic control unit couples the photovoltaic cells as a function of at least one among one or more user-settable parameters, one or more signals received from an external control unit, one or more signals received from one or more sensors included in the electrochemical cell.

### TECHNICAL FIELD

The present description relates to electrochemical cells (for example, electrolyzers or electrochemical reactors), and to the corresponding apparatuses for producing chemical products, such as for example hydrogen produced by electrolysis.

### TECHNOLOGICAL BACKGROUND

The global energy demand is growing and in the year 2020 it was approximately 150000 TWh. Approximately 35 billion tons of carbon dioxide (CO₂) and many other pollutant substances are emitted each year for the production of this amount of energy.

The transformation of solar energy into energy that can be used for human activities using photovoltaic systems presents problems in the storage of the produced energy, insofar as storage systems such as batteries have a low energy density so that they are inconvenient for many applications and for prolonged storage. It is therefore desirable to convert solar energy directly into energy vectors of a chemical nature, such as for example hydrogen.

Hydrogen represents a fuel of great interest, particularly in the energy industry and in the transport industry, by virtue of its high energy density per unit mass (or specific energy). Hydrogen can be produced by extracting it from natural compounds in many different ways; to date, however, the majority of hydrogen produced globally is obtained starting from fossil fuels. For instance, the so-called brown hydrogen is produced from coal in a process known as gasification, whereas grey hydrogen is extracted from natural gas by means of a process known as “steam reforming” of methane. Both of the processes emit large amounts of carbon dioxide. The so-called blue hydrogen is produced from fossil fuels, using at the same time a technology of capture and storage of carbon that reduces the emissions of carbon dioxide into the atmosphere.

Another way to produce hydrogen is based on the process of electrolysis. In the process of electrolysis, an electrolytic cell divides a compound into its constituent elements using an electric current. In the case considered herein, the starting compound is water, which is split into hydrogen and oxygen in a so-called water-splitting reaction. In the case where the electrical energy that supplies the electrolytic cell comes from renewable sources, such as wind-power or solar-generation sources, the hydrogen produced is defined as “green hydrogen”.

Three types of systems are mainly known in the art that exploit solar energy for the production of hydrogen by electrolysis (the so-called solar-to-hydrogen technologies), i.e., photocatalytic (PC) systems, photoelectrochemical (PEC) systems, and photovoltaic-electrochemical (PV-EC) systems.

Cells of a photocatalytic (PC) type represent water-splitting devices that are simpler in terms of technology and components used in the device. In photocatalytic cells, the photocatalyst material is in the form of powder in solution in the electrolyte, so that the path of transfer of charge between the two electrodes of the cell is short and the reactions occur rapidly. Hydrogen and oxygen are generated on the same particle of photocatalyst material; consequently, photocatalytic systems require a further process for separating the gases, following upon their production. Generally, photocatalysts are composites constituted by a semiconductor that collects light and one or more co-catalysts. The semiconductor generates electron-hole pairs following upon absorption of photons with an energy higher than the band-gap of the semiconductor material, whilst on the co-catalyst the hydrogen-evolution reaction (HER) and the oxygen-evolution reaction (OER) occur.

Cells of a photoelectrochemical (PEC) type are generally obtained by means of photoelectrodes (photoanodes and/or photocathodes) connected to charge collectors and electrically connected together. Conventionally, only the light-absorbing side of the photoelectrode is in contact with the electrolytic phase, whereas the side connected to the charge collector is isolated from the liquid. A photoelectrochemical cell typically comprises:
a single photocathode of a p type;
an OER catalytic anode or a photoanode of an n type; and
an HER catalytic cathode.

The photoelectrochemical cells having the configurations referred to above require application of external voltages for compensating over-voltages and overall losses. A practicable way to supply this additional potential consists in combining the photocathode/photoanode system (i.e., the PEC cell) with a photovoltaic cell, to obtain a photovoltaic-photoelectrochemical (PV-PEC) cell.

Photovoltaic-electrochemical (PV-EC) systems are made up of a photovoltaic device, which supplies the energy necessary for triggering the water-splitting reaction, connected to a selected electrocatalyst material. Consequently, the efficiency of the PV-EC cells depends on both the performance of the photovoltaic cell and the performance of the electrocatalyst.

Photovoltaic-electrochemical devices (PV-EC) offer some advantages over PC and PEC systems. In particular, PV-EC devices do not suffer from the problem of corrosion and low stability of the light-absorber insofar as, in some configurations, immersion of the photovoltaic element in the solution and reagents of the electrochemical phase contact of the or direct photovoltaic element itself therewith is not envisaged. In addition, the fact that photogeneration of the charges (electron-hole pairs) and electrocatalysis occur separately renders the system easily scalable, enabling independent modulation of the dimensions of the photovoltaic cell and of the electrocatalyst. On the other hand, the complexity of the individual systems and of their arrangement in communication and synergy results in an increase of the overall cost of PV-EC devices, which represents the main disadvantage of cells of a PV-EC type.

The U.S. patent application published as US 2018/0171492 A1 and the document “Direct Solar-to-Fuel CO₂ Reduction”, Alessandro Monticelli, University of Illinois in Chicago, Thesis, 2015 (available online at the following Internet address: https://hdl.handle.net/10027/19561) describe a simple electrolytic cell suited for producing syngas (a mixture of hydrogen and carbon monoxide) starting from water and carbon dioxide. In general, document US 2018/0171492 A1 mainly teaches chemical-catalytic aspects about the reactions of reduction of CO₂. According to this document, the reaction half-chambers and the photovoltaic cell of the electrolytic cell are arranged in such a way that the photovoltaic cell is in electrical contact with the anode and the cathode, and the two reaction half-chambers are in ionic contact with one another.

The known devices described in the two documents referred to above are, however, characterized by a low efficiency and by difficult scalability to dimensions better suited to industrial and commercial realities, with a consequent low possibility of use in the industrial field.

### OBJECT AND SUMMARY

In view of the above, there is a need in the art to provide improved electrochemical cells that are suited to use in the industrial field. For instance, it is desirable to provide electrochemical cells that enable production of chemical products supplied directly by solar energy and that are able to produce chemical energy vectors (e.g., hydrogen) in an extensive manner, enabling distributed and stand-alone production.

An object of one or more embodiments is to provide an electrochemical cell (or electrochemical reactor) integrated with a solar-energy absorption system, having a higher efficiency and a greater versatility of use as compared to known devices.

According to one or more embodiments, such an object may be achieved by an electrochemical cell having the characteristics set forth in the claims that follow.

One or more embodiments may refer to a corresponding apparatus comprising a plurality of electrochemical cells.

The claims form an integral part of the technical teaching provided herein in relation to the embodiments.

In brief, one or more embodiments refer to an electrochemical cell comprising a first reaction chamber, which includes a first electrode, a second reaction chamber, which includes a second electrode, and a membrane-electrode assembly (MEA) arranged between the first reaction chamber and the second reaction chamber. The membrane-electrode assembly comprises an ion-exchange membrane. The electrochemical cell further comprises a photovoltaic system configured to absorb solar energy and produce an output voltage between a first output terminal and a second output terminal of the photovoltaic system. The first output terminal of the photovoltaic system can be selectively coupled to the first electrode, and the second output terminal of the photovoltaic system can be selectively coupled to the second electrode. The ratio between the photosensitive area of the photovoltaic system and the active area of the first electrode and second electrode is less than or equal to fifty.

Moreover, in one or more embodiments, the photovoltaic system comprises a plurality of photovoltaic cells that can be selectively coupled between the first output terminal and the second output terminal of the photovoltaic system a series configuration, in a parallel configuration, or in one or more mixed series/parallel configurations. A mixed series/parallel configuration is to be understood as a configuration in which the cells are arranged in groups, each group comprises a plurality of cells connected in parallel, and the various groups of cells are connected in series. The electrochemical cell comprises an electronic control unit configured for coupling the photovoltaic cells in a configuration selected between said configurations as a function of one or more parameters that can be set by a user, and/or one or more signals received from an external control unit, and/or one or more signals received from one or more sensors included in the electrochemical cell.

One or more embodiments refer to an apparatus comprising a plurality of electrochemical cells according to one or more embodiments, a first storage reservoir in fluid communication with the first reaction half-chambers of the electrochemical cells for receiving a first gaseous product of reaction, a second storage reservoir in fluid communication with the second reaction half-chambers of the electrochemical cells for receiving a second gaseous product of reaction, and an apparatus electronic control unit. The apparatus further comprises a first circuit for distribution of a first reaction liquid in fluid communication with the first reaction half-chambers of the electrochemical cells, and a second circuit for distribution of a second reaction liquid in fluid communication with the second reaction half-chambers of the electrochemical cells. The first distribution circuit comprises a first apparatus pump controlled by the apparatus electronic control unit to regulate the flow of the first reaction liquid introduced into the first distribution circuit, and the second distribution circuit comprises a second apparatus pump controlled by the apparatus electronic control unit for regulating the flow of the second reaction liquid introduced into the second distribution circuit.

### BRIEF DESCRIPTION OF THE DRAWINGS

Various embodiments will now be described, purely by way of example, with reference to the annexed drawings, wherein:

FIG. 1 is an exploded view of an electrochemical cell according to one or more embodiments;

FIG. 2 is an exploded of 2 an view the electrochemical cell of FIG. 1, in which some operating principles of the electrochemical cell are highlighted;

FIG. 3 is a diagram exemplary of the operating principles of an electrochemical cell according to one or more embodiments;

FIG. 4 is a diagram of an apparatus for the production of chemical products comprising a plurality of electrochemical cells, according to one or more embodiments;

FIG. 5 is a diagram of an embodiment of the apparatus of FIG. 4;

FIG. 6 is a diagram of a further embodiment of the apparatus of FIG. 4;

FIGS. 7A to 7H are various front, axonometric, and cross-sectional views that illustrate some details of implementation of an electrochemical cell according to one or more embodiments;

FIG. 8A is an exploded view of some components of an electrochemical cell according to one or more embodiments;

FIGS. 8B and 8C are exploded views of some components of an electrochemical cell according to one or more embodiments;

FIGS. 9 to 12 are current-to-voltage diagrams exemplary of operating principles of one or more embodiments;

FIGS. 13A and 13B are exemplary of operation of one or more embodiments according to a first example of configuration;

FIGS. 14A and 14B are exemplary of operation of one or more embodiments according to a second example of configuration;

FIG. 15 is a diagram exemplary of possible details of implementation of an electrochemical cell according to one or more embodiments;

FIGS. 16A and 16B are exemplary of operation of one or more embodiments according to a third example of configuration; and

FIG. 17 is a view of an apparatus according to one or more embodiments.

### DETAILED DESCRIPTION

In the ensuing description one or more specific details are illustrated, aimed at enabling an in-depth understanding of examples of embodiment of the present description. The embodiments may be obtained without one or more of the specific details, or with other methods, components, materials, etc. In other cases, known structures, materials, or operations are not illustrated or described in detail so that certain aspects of the embodiments will not be obscured.

Reference to “an embodiment” or “one embodiment” in the context of the present description is intended to indicate that a particular configuration, structure, or characteristic described in relation to the embodiment is comprised in at least one embodiment. Consequently, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments.

In all the figures annexed hereto, unless the context indicates otherwise, parts or elements that are similar are designated by references/numbers that are similar, and a corresponding description will not be repeated herein for brevity.

The references used herein are provided merely for convenience and consequently do not define the sphere of protection or the scope of the embodiments.

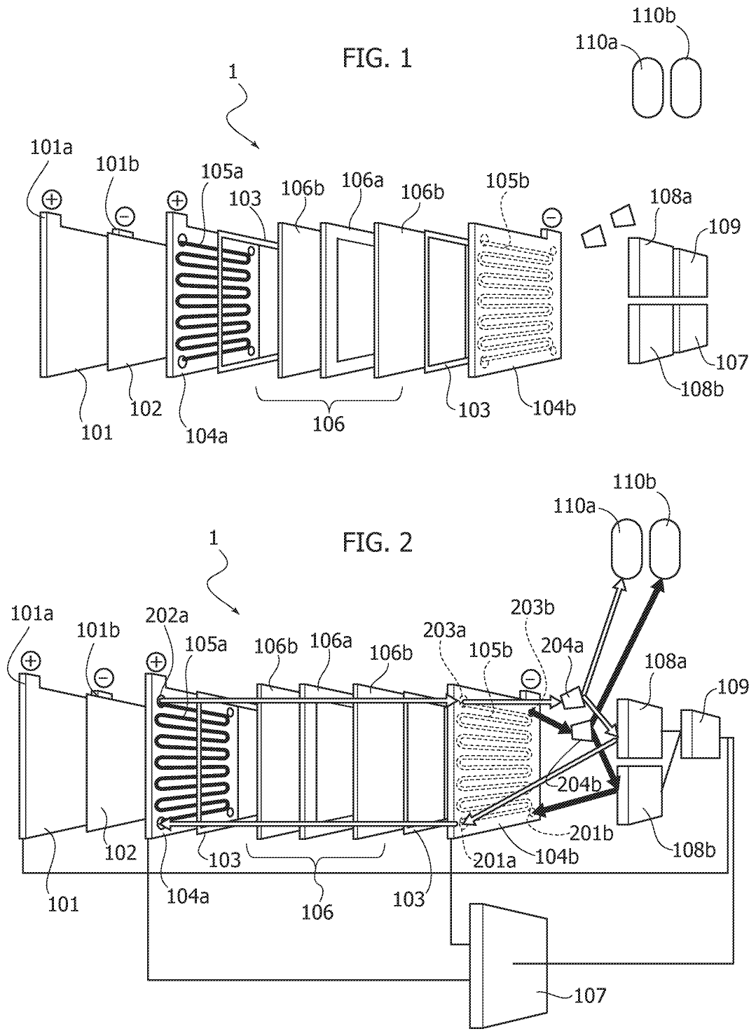

FIG. 1 is an exploded view of an electrochemical cell 1 (or electrochemical reactor) according to one or more embodiments, in which some components of the cell 1 are represented.

The electrochemical cell 1 comprises a photovoltaic system 101 (e.g., a photovoltaic panel) configured for absorbing solar energy and converting it into electrical energy (current and voltage available at the output terminals 101a, 101b of the system 101) for supplying the electrochemical cell.

The electrochemical cell 1 comprises gaskets 103, insulating elements 102, sealing elements, and fluid-tight elements configured for electrically insulating some components (e.g., for electrical insulation of the photovoltaic system 101 from the outer wall of the reaction chamber of the electrochemical cell 1) and/or for maintaining fluid tightness of the reaction chambers, preventing dispersion of liquids and/or gases towards the environment external to the electrochemical cell 1.

The electrochemical cell 1 comprises a first conductive plate 104a and a second conductive plate 104b that operate as electrodes in contact with the two reaction half-chambers of the electrochemical cell 1 in such a way that a chemical reaction can occur in the reactor when an electrical potential difference is applied between the two conductive plates (one for the anode and one for the cathode). For instance, as illustrated in FIG. 1, the plate 104a can be electrically coupled to the positive terminal 101a of the photovoltaic system 101, and the plate 104b can be electrically coupled to the negative terminal 101b of the photovoltaic system 101. Moreover, each plate 104a, 104b comprises one or more flow channels 105a, 105b for flow of the reagents in the respective reaction half-chamber (for example, according to a serpentine configuration). Such channels enable internal distribution of the fluids in order to maximize the exchanges during the chemical reaction.

The electrochemical cell 1 comprises a membrane-electrode assembly (MEA) 106, which comprises an anionic-exchange membrane (AEM) 106a or a proton-exchange membrane (PEM) 106a, one or two layers of catalyst material (one for the anode side and one for the cathode side), and two gas-diffusion layers (GDL) 106b. In particular, the MEA 106 can be structured according to a CCS (Catalyst-Coated Substrate) configuration, in which the catalyst material is arranged on a substrate, or else according to a CCM (Catalyst-Coated Membrane) configuration, in which the catalyst material is arranged on the membrane 106a.

Consequently, the conductive plates 104a and 104b can operate directly as electrodes or as conductive elements that supply the membrane-electrode assembly 106.

The electrochemical cell 1 comprises a system for temporary storage (buffer) of energy 107, for example a battery, that can be selectively coupled to the photovoltaic system 101.

The electrochemical cell 1 comprises one or more pumps 108a, 108b (e.g., micro-pumps such as piezoelectric pumps). For instance, the cell 1 may comprise a pump 108a that enables anode recirculation or flow, and a pump 108b that enables cathode recirculation or flow.

The electrochemical cell 1 comprises an electronic control unit 109 (e.g., a PLC) configured for managing operation of the electrochemical cell 1, as further described in the sequel of the present description. For instance, the control unit 109 can be configured for regulating the system for recirculation of the reagents by operating the pumps 108a, 108b as a function of one or more signals detected by one or more flow-rate sensors (not illustrated in FIG. 1) installed in the electrochemical cell 1. In addition or as an alternative, the control unit 109 may be configured for regulating the working point (i.e., the pair of current-voltage values j, V applied to the electrodes of the cell 1) of the electrochemical system by dynamically configuring the photovoltaic system 101. In addition or as an alternative, the control unit 109 may be configured for controlling the energy-buffer system 107 to enable the electrochemical reactor to operate continuously.

In one or more embodiments, the pumps 180a and 108b, the energy-buffer system 107, and/or the circuits of the electronic control unit 109 can be integrated within the electrochemical cell 1.

Also shown in FIG. 1 are the gas reservoirs 110a, 110b, which are configured to be coupled in fluid communication with the two reaction half-chambers (anodic and cathodic) of the cell 1 to collect the respective products of reaction.

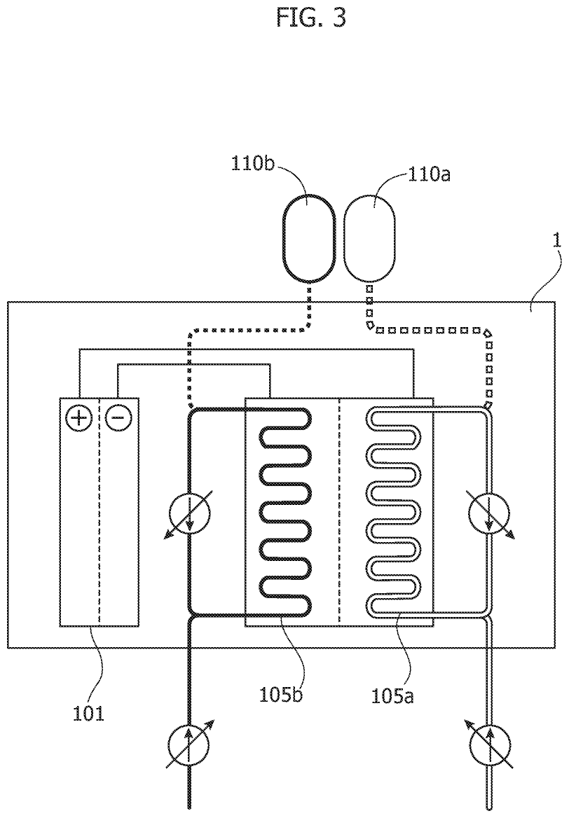

FIG. 2 is an exploded view of the electrochemical cell 1 described with reference to FIG. 1, in which the main flows of liquids and gases, as well as some electrical connections between the various components of the cell 1, are represented. FIG. 3 is, instead, a simplified diagram of the cell 1 that also shows schematically the main flows of liquids and gases and some electrical connections between the various components of the cell 1.

As exemplified in FIGS. 2 and 3, the cell 1 is configured in such a way that a delivery of liquid (cathode reagents) supplies the circuit that from the intake hole 201a carries the liquid onto the cathode side 104a of the electrochemical cell 1 and supplies the flow channels 105a. Once the liquid has been introduced into the flow channels 105a, in contact with the MEA 106, it reacts with the liquid introduced into the anode circuit 105b and is partially converted into products of reaction in gaseous form. The mixture containing the reagents that are partially not converted and the gaseous product reaches an outlet hole 202a of the plate 105a, passes through the cell 1, arrives at the hole 203a, and then passes through a split valve 204a that separates the gaseous product, which is conveyed towards the respective storage reservoir 110a, from the reagents not yet converted, which will be re-introduced into circulation through the pump 108a, thus restarting the conversion cycle. In a similar way, on the anode side a delivery of liquid (anode reagents) supplies the circuit that from the hole 201b carries the liquid directly through the anode flow channels 105b. Once the liquid has been introduced into the channels 105b, in contact with the MEA 106, it reacts with the liquid of the cathode circuit and is partially converted into products in gaseous form. The mixture containing the reagents that are partially not converted and the gaseous product reaches an outlet hole 203b and passes through a split valve 204b that separates the gaseous product, which is conveyed towards the respective storage reservoir 110b, from the reagents not yet converted, which will be re-introduced into circulation through the pump 108b, thus restarting the conversion cycle.

In one or more embodiments, the photovoltaic system 101 is configured for supplying the electric power necessary for operation of the electrochemical reactor 1, and the control unit 109 is configured for regulating and distributing the above power between the various components of the cell 1. In particular, as further described in the sequel of the present description, the photovoltaic system 101 comprises a plurality of photovoltaic cells, the electrical connections of which are (dynamically) reconfigurable in various series/parallel modes in order to convert the solar power absorbed into various possible current-voltage (j-V) combinations and be able to supply the electrochemical cell 1 in the most efficient way to increase the amount of products of reaction (i.e., to increase the efficiency of the electrochemical cell). This (dynamic) reconfiguration of the series-parallel connections of the photovoltaic cells in the photovoltaic system 101 is performed by the control unit 109.

In particular, the control unit 109 can be configured for performing one or more of the following functions:
regulating the operating parameters of the electrochemical cell 1 by opening and closing the electrical and power connections and by regulating operation of the subcomponents of the electrochemical cell 1, as a function of programmed logics and/or of signals detected by one or more sensors internal to the electrochemical cell 1 (e.g., flow-rate sensors, ammeters, voltmeters) and/or of signals received from outside (e.g., from an external interface, from an Internet-of-Things device);
regulating the system in order to approach as much as possible the ideal operating parameters for a given chemical reaction, and sending a feedback to the outside, having received as input from outside the ideal values of the operating parameters of one or more selected electrochemical reactions;
regulating operation of the recirculation pumps 108a, 108b as a function of the variations of flow rate and as a function of the difference between the flow rate at input to the electrochemical cell 1 and the flow rate at output from the electrochemical cell 1;
configuring the electrical connections of the photovoltaic system 101 in order to use part of the power generated by the photovoltaic system 101 for charging the energy-buffer system 107; in particular, the part of power thus used may be equal to the difference between the power absorbed from the solar radiation and the power that can be converted into current useful for the electrochemical reaction (i.e., it may represent an energy surplus that cannot be used instantaneously to activate the chemical reaction).

In one or more embodiments, the energy-buffer system 107 can electrically supply the control unit 109 and/or the pumps 108a, 108. In addition or as an alternative, the energy-buffer system 107 can supply a minimum current and voltage to the electrochemical cell 1 in the hours of nocturnal inactivity so as to increase the speed and efficiency of start-up of the electrochemical cell 1 in the morning (when the photovoltaic system 101 starts to convert solar radiation into electrical energy) and so as to slow down deterioration of the chemico-catalytic components of the cell 1, thus lengthening the service life and increasing the stability of the system.

In addition or as an alternative, in one or more embodiments the energy-buffer system 107 may make up for possible oscillations, interruptions, and/or sudden variations of the production of electrical energy by the photovoltaic system 101 in order to increase the stability of the chemical reaction that takes place in the electrocatalytic system.

One or more embodiments may regard a system that comprises a plurality of electrochemical cells 1, as discussed with reference to FIGS. 1 to 3. The cell 1 may hence constitute a modular unit of a more complex system, for example a panel comprising a plurality of electrochemical cells, each having associated thereto a respective photovoltaic panel.

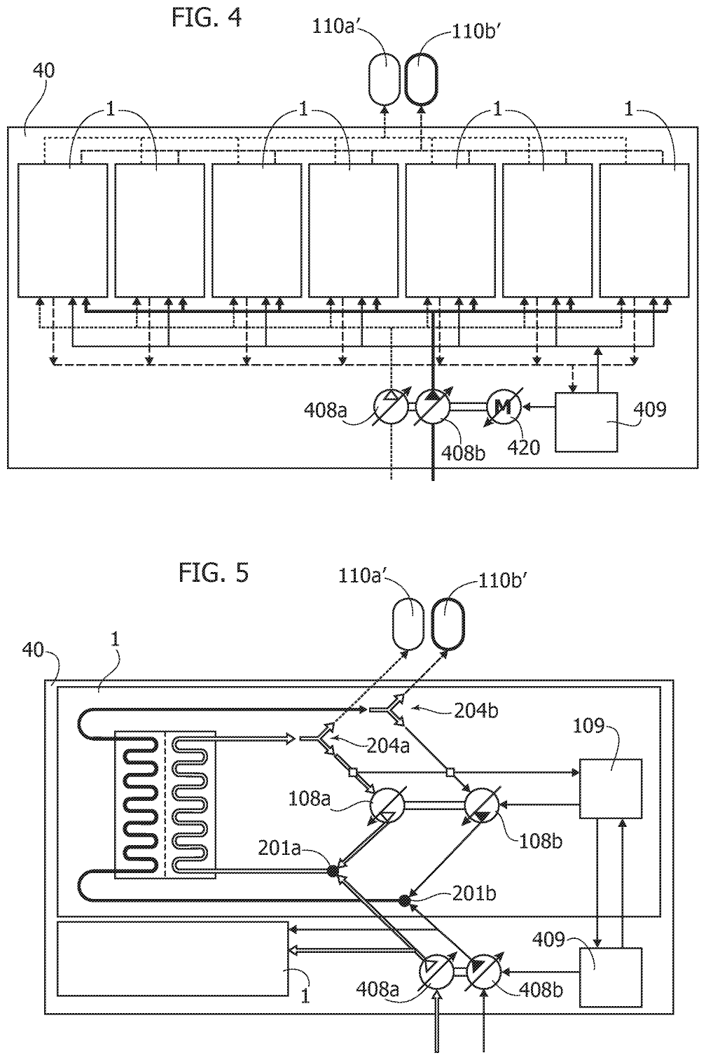

FIG. 4 is a diagram exemplifying such a system 40 comprising a plurality of cells 1, according to one or more embodiments. Represented in FIG. 4 is the diagram of the main flows of liquids (thick solid line and short-dashed line), flows of gases/products (dashed lines towards the reservoirs 110a′, 110b′) and electrical signals (fine solid line and long-dashed line) that regulate the system 40 comprising a plurality of electrochemical cells 1 that operate synergistically.

In particular, in such a system two reservoirs 110a′, 110b′ may be present for the products of reaction in common to all the cells 1. The system 40 may moreover comprise two pumps 408a, 408b supplied by an electric motor 420. The first pump 408a can receive from a respective fluidic input the liquid containing the anode reagents and convey it towards the respective pumps 108a of each cell 1. Likewise, the second pump 408b can receive from a respective fluidic input the liquid containing the cathode reagents and convey it towards the respective pumps 108b of each cell 1. The arrangement of common pumps 408a, 408b and dedicated pumps 108a, 108b enables improvement of control and distribution of the reagents in all the cells.

In addition, the system 40 may comprise a common electronic control unit 409 (for example, a PLC) that controls the motor 420 that drives the pumps 408a, 408b. The common control unit 409 may moreover be connected to each local control unit 109 of each cell 1 in order to exchange control and/or feedback signals therewith.

Consequently, in one or more embodiments as exemplified in FIG. 4, a variable-flow intake pump 408a, regulated by the common control unit 409, sends the fluid to the various cells 1 for the anode side (and the same for the cathode side, by means of the variable-flow intake pump 408b). The reactions occur within the electrochemical cells 1, and the various split valves (provided in the cells 1) separate the gaseous products from the liquid reagents, and convey the former in purposely provided circuits for the anode and cathode products (which are then collected in the respective reservoirs 110a′, 110b′) and the latter once again through the cells 1.

For instance, FIG. 5 is a diagram exemplifying the system 40 where one of the electrochemical cells 1 comprised therein is represented in greater detail. The local control unit 109 of the cell 1 exchanges control and/or feedback signals with the common control unit 409. The fluids received via the ducts controlled by the pumps 408a, 408b are introduced into the electrochemical cell 1 through the respective intake holes 201a, 201b as a function of the local control obtained via the pumps 108a, 108b controlled by the local control unit 109.

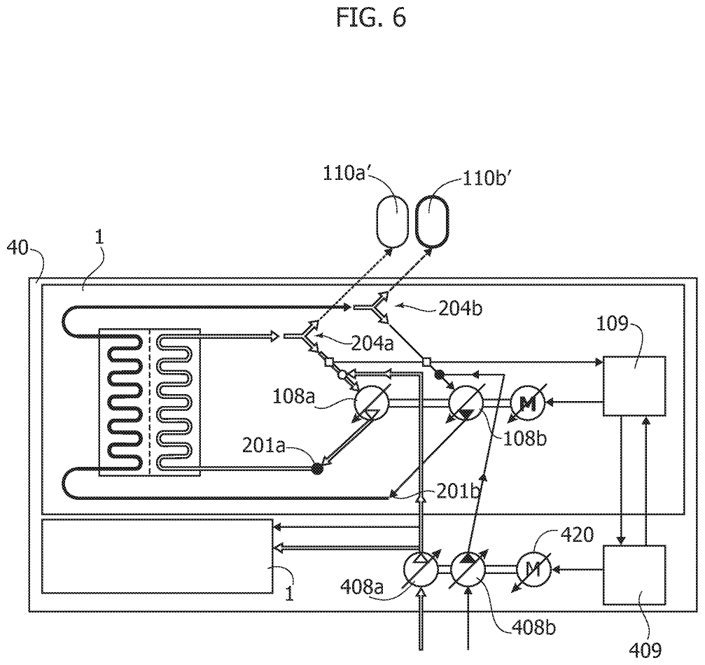

FIG. 6 is a diagram exemplifying a variant embodiment of the system 40, in which a different connection is represented between the local fluid ducts of the cell 1 and the common fluid ducts controlled by the pumps 408a, 408. In particular, in this configuration, the liquids are introduced into the local recirculation system in a section of the ducts intermediate between the split valves and the pumps, i.e., upstream of the pumps 108a, 108b. Obviously, the person skilled in the art will understand that numerous alternative configurations are possible that achieve the same functions as those described herein, all of which are comprised within the scope of the present invention.

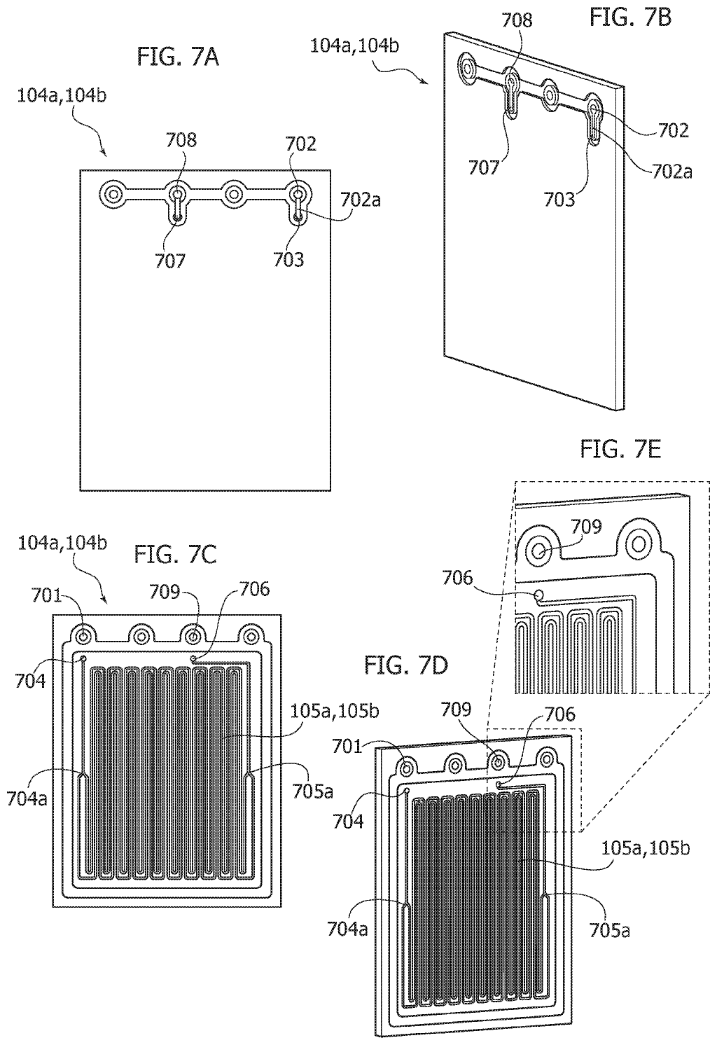

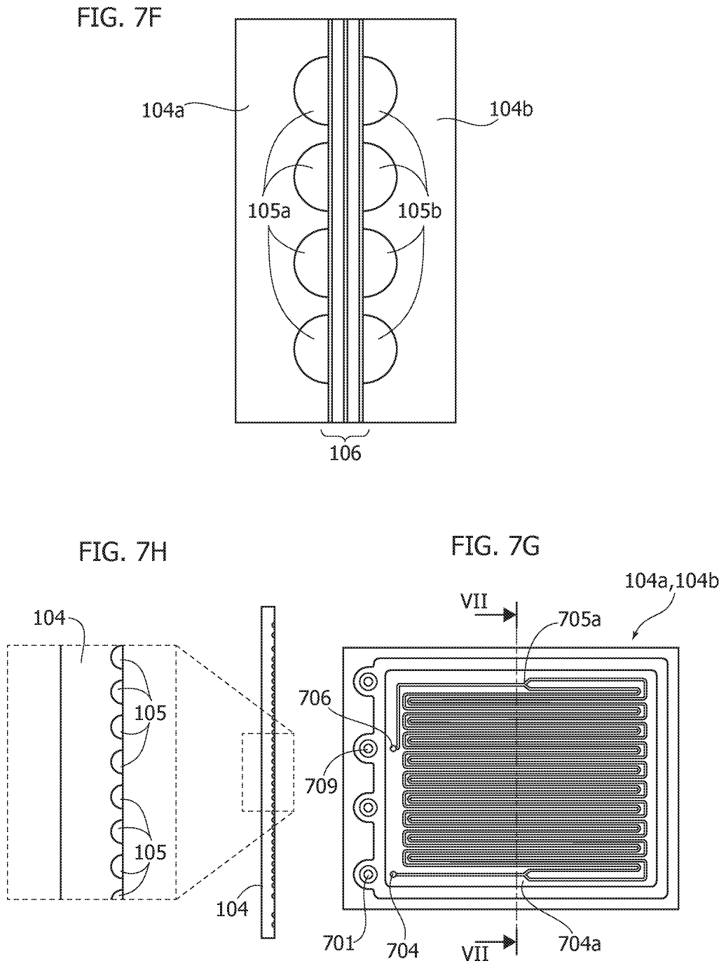

FIG. 7A is a front view exemplary of a rear surface of a conductive plate (e.g., the anode plate or the cathode plate) for use in an electrochemical cell according to one or more embodiments. FIG. 7B is an axonometric view of the same rear surface as that illustrated in FIG. 7A. FIG. 7C is a front view exemplary of a front surface (i.e., facing the inside of the reaction chamber) of the conductive plate of FIGS. 7A and 7B. FIG. 7D is an axonometric view of the same front surface as the one illustrated in FIG. 7C. Represented in FIG. 7E is an enlarged portion of the conductive plate of FIG. 7D.

FIGS. 7A-7E illustrate in detail an example of the structure of the flow channels 105a, 105b provided on the faces of the conductive plates 104a, 104b that face the reaction chamber. The flow of water-based reagents from the inlet reaches the conductive plate from the front side (illustrated in FIGS. 7C-7E) and passes through the plate passing from the (front) point 701 to the (rear) point 702. Through a mini-channel 702a the flow drops to the point 703 and once again passes through the plate, passing from the (rear) point 703 to the (front) point 704. From the point 704 the liquid full of reagents (e.g., anode reagents) flows through the flow channels (105a, 105b), where it is in contact with the flows (e.g., cathode flows) in counter-current that flow in the second conductive plate, separated by the ion-exchange membrane, and is transformed into products. In one or more embodiments as exemplified herein, in order to increase the surface of exchange, while slowing down the speed of the constant-flowrate fluid, the flow channels fork in the point 704a and then join up in the point 705a. Finally, the mixed flow of gaseous products and liquid reagents reaches the point 706. From here the flow again passes through the plate and then passes to the point 707 at the rear side and reaches the main duct (point 708 on the rear side, then again through the plate up to the point 709 on the front side). From the main duct, the flow reaches the respective split valve so that its liquid part (non-transformed reagents) circulates once again in the reaction chamber, and its gaseous part is collected in the respective reservoir.

Highlighted in FIG. 7E is the structure of the flow channels, which may be similar to capillary vessels with semi-circular section which are closed, on the front surface, by the MEA 106 (not visible in FIGS. 7A-7E).

FIG. 7F is a (lateral) sectional view that represents the inside of an electrochemical cell 1 according to one or more embodiments. As discussed with reference to FIG. 1, the cell 1 comprises two conductive plates 104a, 104b having respective channels 105a, 105 for the flow of the reagents (e.g., serpentines) engraved into the facing surfaces of the plates 104a and 104b in corresponding positions in such a way that the two liquids (anode and cathode liquids) flow on the two opposite sides of the MEA 106 in corresponding positions, and chemical exchange can take place through the membrane. The liquid with the reagents of the cathode half-reaction flows through the cathode channels 105a, and the liquid with the reagents of the anode half-reaction flows through the anode channels 105b. In the presence of a potential difference applied to the conductive plates 104a, 104b, and thanks to the catalysts contained in the MEA 106, there is stimulated the electrochemical reaction that closes the electrical circuit and produces products in gaseous form. The products in gaseous form are conveyed, together with the non-transformed reagents, through the flow channels up to the split valve, which separates the gaseous products from the non-transformed reagents. The latter can be sent back into circulation.

FIG. 7G is a further front view exemplary of the front surface (i.e., facing the inside of the reaction chamber) of the conductive plate of FIGS. 7A-7E. FIG. 7H is a cross-sectional view of the conductive plate illustrated in FIG. 7G, obtained by sectioning in a transverse direction along the line indicated by VII-VII in FIG. 7G. Illustrated in the left-hand portion of FIG. 7H is an enlargement of the cross-sectional view, which highlights the semicircular structure of the flow channels 105 provided on the front surface of the conductive plate 104.

Consequently, one or more embodiments may comprise an independent fluid-dynamic system for recirculation, collection, and/or separation of the (gaseous) products. In particular, one or more embodiments may comprise a system for distribution and microfluidic recirculation that enables an increase in the surface of the electrodes in contact with the reagents and a reduction of the head losses. For instance, one or more embodiments are characterized by a structure that facilitates separation of the gaseous part (products) from the liquid part (reagents). The fluid-dynamic system has the function of distributing the reagents at input (in liquid form) both on the anode side and on the cathode side, maximizing the surface of contact between the liquid and the surface of the electrodes and the ion-exchange membrane (for example, a proton-exchange membrane—PEM—or anion-exchange membrane—AEM) enabling the system to work with continuous flow.

In addition, one or more embodiments may comprise one or more sensors for regulation of the fluid-dynamic and recirculation system. Circulation and/or recirculation of reagents and products in the microfluidic system may be obtained via pressure variations and may be regulated by a system comprising one or more sensors that monitor the operating parameters of the reactor. In particular, a system for managing the flows according to various embodiments may comprise two sub-systems: a first system for managing the flows in the individual electrochemical cell, and a second system for managing the flows in the system made up of a number of cells connected to one another, as exemplified in FIGS. 4 to 6 previously described.

In one or more embodiments, the system for managing the flows in the system made up of a number of electrochemical cells is configured for conveying the output flows of the cells into a single duct and for supplying the individual input ducts of the reagents of the individual electrochemical cells starting from a single main duct of reagents. For instance, the flow-management system may comprise non-return valves and pressure switches that can be regulated as a function of the working points chosen on the basis of the chemical reactions that take place in the individual electrochemical cells. For instance, one or more embodiments may comprise a control unit (for example, a microprocessor) configured for regulating and managing the working points of the electrochemical cells both in an automatic way (for example, according to pre-set regulations and parameters) and in a parametric or manual way (for example, by entering the desired operating parameters via a user interface). This solution increases the flexibility of use of the electrochemical system to the degree in which it enables updating and/or modifying the parameters of use according to the reactions that are to be carried out into the electrochemical cell and/or according to the variations of the catalytic systems used, without any need to make structural modifications to the electrochemical cells.

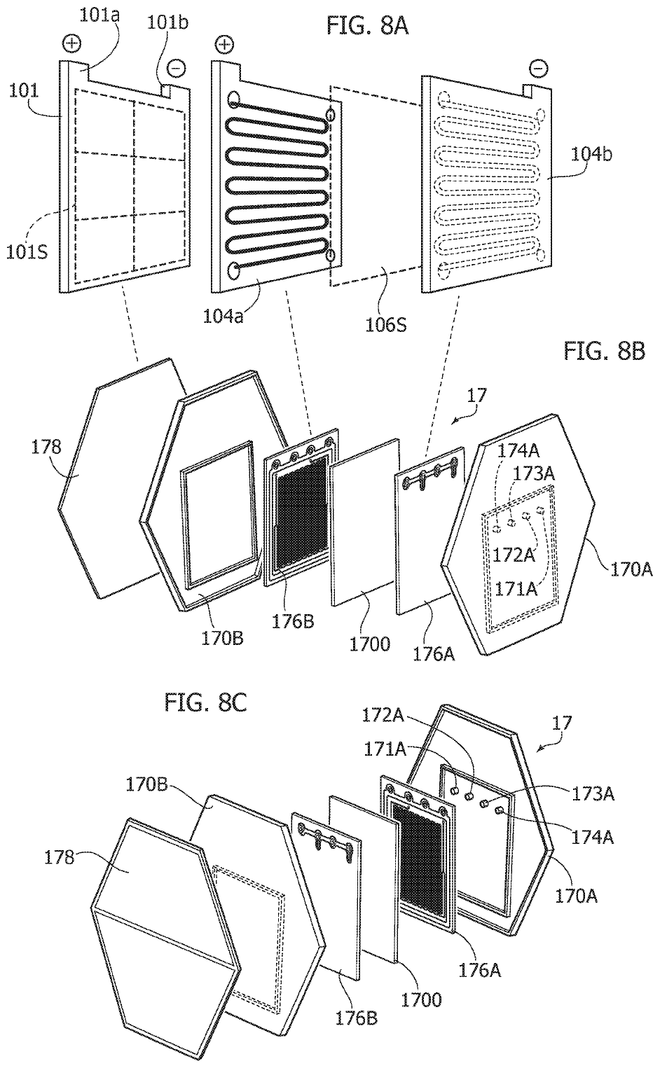

FIG. 8A is an exploded view of some components of an electrochemical cell 1 according to various embodiments. FIG. 8B is a corresponding exploded rear view of a preferred embodiment. FIG. 8C is an exploded front view of the electrochemical cell illustrated in FIG. 8B.

In particular, illustrated in FIG. 8A are the photovoltaic panel 101 and the two conductive plates 104a, 104b. In addition, schematically represented in FIG. 8A is the area 101S, i.e., the area of the surface of the photovoltaic panel 101 (divided, in this example, into six regions, in so far as the photovoltaic panel 101 may comprise a plurality of photovoltaic cells that can be connected in series and/or in parallel according to the need). Also schematically represented in FIG. 8A is an area 106S, i.e., the active area of the surface of the electrodes of the cell 1. The area of the electrodes to be considered active is the area of ion exchange between the first reaction half-chamber and the second reaction half-chamber, and is consequently common to both electrodes.

FIGS. 8B and 8C are exploded views of an electrochemical cell 17 according to one or more embodiments of the invention. The electrochemical cell 17 is suited, in particular, for functioning in a PV-EC configuration with the photovoltaic element not immersed in the reaction chamber, but outside the chamber itself. The electrochemical cell 17 comprises a first frame element 170A, which includes a plate preferably made of plastic material. As exemplified in FIGS. 8B and 8C, the shape of the frame element 170A may be preferably hexagonal, but also square or rectangular, as in the other embodiments described herein.

The plate comprises, on a face thereof (i.e., the “inner” face of the electrochemical cell), a recessed portion (preferably of a square or rectangular shape), which defines the volume of the first reaction half-chamber. This recessed portion is in fluid communication with the external environment by means of the ducts 171A, 172A, 173A, 174A that pass through the frame element 170A. The recessed portion is configured for receiving within it a tessera-like (tile-like) element 176A that defines a first reaction half-chamber and operates as charge collector for the first half-chamber (corresponding to the conductive plate 104b of FIG. 8A).

The electrochemical cell 17 further comprises an ion-exchange membrane 1700, which separates the first reaction half-chamber, defined by the tessera-like element 176A, from the second reaction half-chamber defined by a similar second tessera-like element 176B (corresponding to the conductive plate 104a of FIG. 8A) received in the recessed portion of a second frame element 170B. As exemplified in FIGS. 8B and 8C, the second frame element may not be provided with any duct for fluid communication between the recessed portion and the external environment. The frame elements and the ion-exchange membrane may comprise perimetral holes (not visible in the annexed drawings) for assembling the electrochemical cell 17.

In one or more embodiments, the electrochemical cell 17 comprises a photovoltaic cell 178 (corresponding to the photovoltaic element 101 of FIG. 8A), electrically coupled to the electrodes.

The electrochemical cell 17 is configured for operating in continuous-flow mode, using a photovoltaic system 178, an electrical system, a catalytic system, and a system for management of the flows and collection of the products (gaseous products, for example hydrogen), as described previously. In particular, the electrochemical cell 17 may be provided with a continuous-flow system and a recirculation system, a system for absorption and conversion of light, and a configuration that minimizes the losses and maximizes the synergy and versatility of the system.

In particular, as exemplified in FIGS. 8B and 8C, the charge collectors 176A, 176B of the electrochemical cell 17 may comprise one or more etched channels having a serpentine configuration, which distribute the flow over the active surface of the electrode and of the membrane 1700, maximizing the surface of exchange and the time of contact given the same rate of the flow that passes through the cell, to obtain an improvement of the amount of reagents converted into products given the same flow rate. In one or more embodiments, the system of channels at the anode is arranged overlying the channels at the cathode in such a way that the two flows are in countercurrent with the purpose of maximizing the proton/anion exchange and increase the conversion rate.

As discussed previously, in one or more embodiments, the pumps 180a and 108b, the energy-buffer system 107, and/or the circuits of the electronic control unit 109 may be integrated within the electrochemical cell 1. For instance, with reference to FIGS. 8B and 8C, one or more of the systems referred to above may be integrated in the frame element 170A and/or in the frame element 170B.

It has been noted that the integration of photovoltaic technology with electrolyzer technology (or the electrochemical or EC system) in a single system requires supply of the electrochemical system with the highest possible charge density at the potential required by the catalytic system chosen. In known solutions, for this purpose large photovoltaic surfaces are used for supplying a single electrolyzer (and hence a single set of electrodes), resulting in a ratio between the photovoltaic surface and the useful surface of the electrodes that is typically much higher than one hundred, even by one or more orders of magnitude. Obtaining a low ratio between the photovoltaic surface and the useful surface of the electrodes, of the order of tens down to unity, is a desirable characteristic that the solutions according to the prior art are unable to achieve. In fact, providing for each square meter of photovoltaic panel as many square meters of electrodes for as many electrolyzers is economically disadvantageous. Furthermore, an electrode having a very large surface (for example, 1 m²), if connected to a photovoltaic panel of the same surface (for example, 1 m²), would present ohmic losses and voltage drops that are so important as not to be able to guarantee the conditions of operation of the electrolytic system, or in any case are such as to jeopardize the efficiency thereof to the point where it becomes economically unsustainable.

In one or more embodiments, in order to maintain the ratio between the photovoltaic surface and the useful surface of the electrodes as low as possible (for example, less than or equal to one hundred, less than or equal to fifty, less than or equal to ten, less than or equal to five, or even equal to one, passing from an intensive configuration to an extensive configuration), at the same time maintaining the conditions necessary for operation of the catalytic system (for example, a current density of at least 8 mA/cm² and a potential difference of at least 1.5 V), the photovoltaic panel is divided into a number of units (for example, each having a surface comprised between 25 cm² and 1 m², optionally between 50 cm² and 25 dm², optionally equal to 100 cm²), which can be electrically coupled directly to electrodes each having a surface comparable to the surface of the photovoltaic unit (for example, once again comprised between 25 cm² and 1 m², optionally between 50 cm² and dm², optionally equal to 100 cm²).

According to the above solution, one or more embodiments relate to a system 40 comprising a plurality of small photovoltaic panels connected to as many small electrochemical cells, which comprise electrodes of dimensions comparable to those of the respective photovoltaic panels that supply them.

One or more embodiments comprise a system for regulation and management of the (integrated) photovoltaic system, which is designed to reduce the ohmic losses and to increase the surface charge density necessary for the reaction by regulating the operating voltage. For instance, the connection of the individual photovoltaic units may be structured in such a way that they can be connected in series, in parallel, or in a combination of the two, thus making possible to regulate the curve of operation of the photovoltaic system to adapt it to the particular electrochemical reaction that occurs in the reactor and to the catalytic system used, thus increasing the efficiency of the photovoltaic electrochemical system. A reactor according to one or more embodiments may comprise a catalytic system chosen on the basis of the specific reaction that is to be obtained, according to the product that it is desired to obtain (for example, hydrogen or syngas). Each reaction and/or each catalytic system may require a different minimum operating voltage. The possibility of setting the connections in series and/or in parallel between the individual photovoltaic units enables variation of the operating voltage applied to the membrane-electrode assembly (MEA), enabling improvement of the electrochemical performance of the system as the catalytic system varies. For instance, the reaction of water-splitting for the production of hydrogen requires a minimum voltage applied to the cell equal to 1.23 V in order for it to take place. However, the particular catalytic system chosen could have maximum efficiency at a voltage of 1.7 V. In this case, in one or more embodiments, it is possible to connect the individual photovoltaic units in a series and/or parallel configuration so that the electrodes are supplied at the maximum possible current density at a minimum voltage of 1.7 V.

Consequently, one or more embodiments may advantageously provide a system for regulation, management, and/or connection of the photovoltaic system to the electrodes of the cell (in particular, to the MEA), which enables increasing the versatility of use of the cell itself.

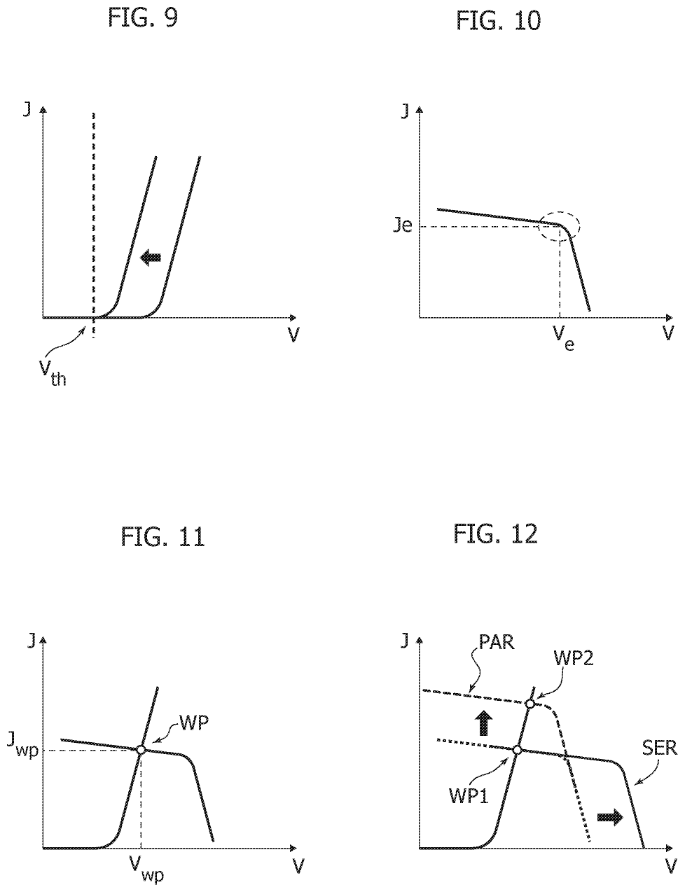

For instance, FIG. 9 exemplifies a typical current-to-voltage (J-V) curve of electrochemical (EC) reaction. The dashed line in FIG. 10 indicates the theoretical potential of the reaction Vₜₕ; the closer the reaction curve approaches (e.g., shifting towards the left) the theoretical reaction curve (dashed line), the higher the efficiency of the electrochemical system and the lower the over-potential losses. FIG. 10 exemplifies a typical current-to-voltage (J-V) curve of a photovoltaic (PV) system. The point of highest efficiency of the photovoltaic system corresponds to the pair of values (Jₑ, Vₑ) that correspond to the elbow of the curve, highlighted by the dashed area of the graph of FIG. 10. The working point (WP) of the photovoltaic-electrochemical system that determines the efficiency of the electrochemical cell and its output rate is determined by the crossing-over of the reaction (EC) curve and of the photovoltaic (PV) curve of the cell, as shown in FIG. 11, where the working point corresponds to the pair of current-voltage values (J_{wp}, V_{wp}). Given the same reaction (EC) curve, the higher the current delivered by the photovoltaic system, the greater the output of the electrochemical reactor (in terms of amount of products of reaction obtained per unit time).

FIG. 12 illustrates how different configurations of the electrical (series/parallel) connections between the various photovoltaic cells comprised in the photovoltaic system 101 can modify the J-V characteristic curve of the photovoltaic system, and consequently alter the working point WP of the electrochemical reactor 1. For instance, by connecting a number of photovoltaic cells in parallel a J-V curve is obtained, with current (J) equal to the sum of the characteristic currents of the individual cells and voltage (V) equal to the voltage of just one cell, as represented by the curve PAR illustrated in FIG. 12. By connecting a number of photovoltaic cells in series a J-V curve is obtained with voltage (V) equal to the sum of the characteristic voltages of the individual cells and current (J) equal to the current of just one cell, as represented by the curve SER illustrated in FIG. 12. The photovoltaic system 101 enables dynamic configuration of the series and parallel connections between the various photovoltaic cells so as to optimize the working point (WP) of the PV-EC system, seeking to get the EC system to work at the maximum current possible for the solar power absorbed and the photovoltaic system as close as possible to the elbow of the photovoltaic curve. For instance, in FIG. 12 the parallel configuration, corresponding to the working point WP2, is more efficient than the series configuration, corresponding to the working point WP1.

Moreover, since the power supplied by the sun, and consequently the power absorbed by the photovoltaic system 101, is not constant during the day and not even throughout the year, to increase the efficiency of the system and guarantee the minimum voltage necessary for the EC reaction to take place it is possible to modify the working point of the system by modifying in a dynamic way the series/parallel connections internal to the photovoltaic system 101, for example according to pre-set logics managed by the electronic control unit 109 of each individual electrochemical cell 1 and/or by the electronic control unit 409 of the system 40.

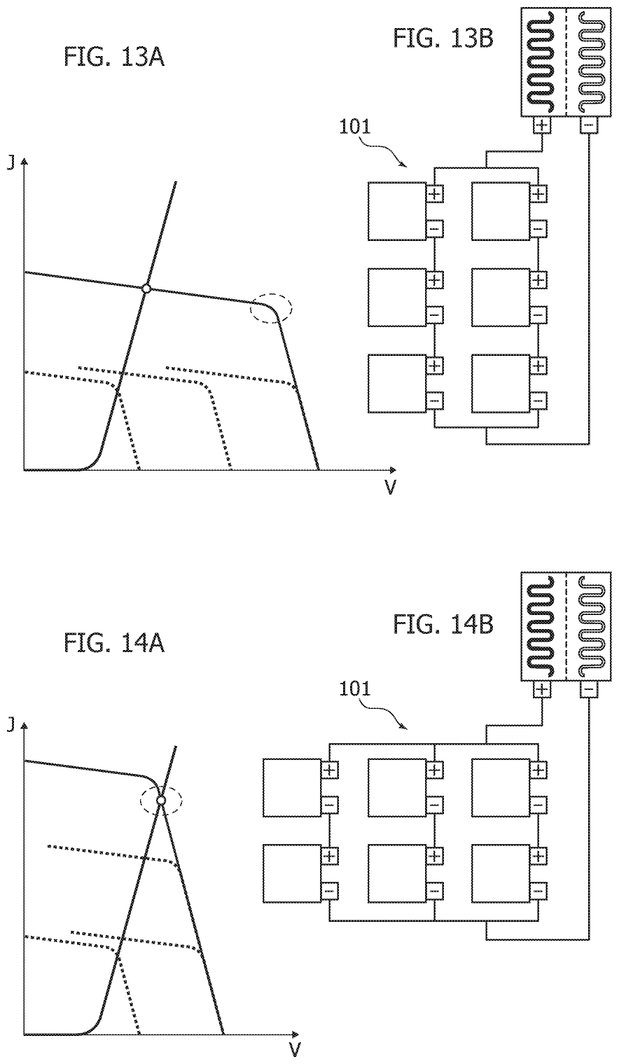

For instance, FIGS. 13A, 13B, 14A, and 14B present a comparison between two different configurations of the same electrochemical cell 1, the photovoltaic system 101 of which comprises—purely by way of example—six photovoltaic cells. In FIGS. 13A and 13B, the six cells are connected in two sets connected in parallel, each set comprising three cells connected in series. In FIGS. 14A and 14B, the six cells are connected in three sets connected in parallel, each set comprising two cells connected in series. Given the same EC reaction curve in both cases, the configuration of FIGS. 14A, 14B determines a working point at a higher current, which results in a higher production of products of the electrochemical cell 1, and the photovoltaic system works closer to the elbow of the PV curve, and consequently with a higher efficiency.

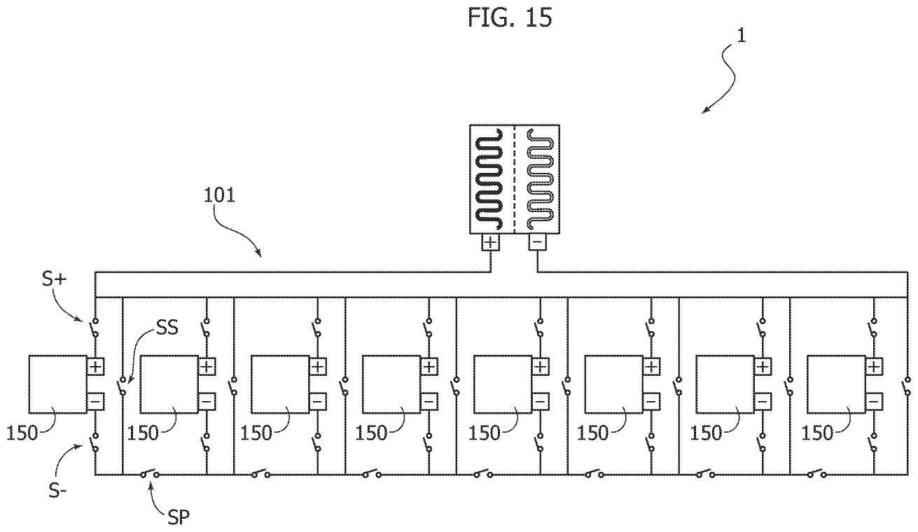

FIG. 15 is a diagram exemplifying one or more embodiments of an electrochemical cell 1, where the photovoltaic system 101 comprises a set of electronic switches controlled by the control unit 109 for modifying in a dynamic way the series and parallel connections of the individual photovoltaic cells comprised in the photovoltaic system 101. In particular, each photovoltaic cell 150 in the photovoltaic system 101 may comprise:
an electronic switch St, which can be activated for coupling the positive terminal of the cell 150 to the positive terminal of the electrochemical cell 1 (anode 105a);
an electronic switch S−, which can be activated for coupling the negative terminal of the cell 150 to the negative terminal of the electrochemical cell 1 (cathode 105b);
an electronic switch SS, which can be activated for coupling the negative terminal of the cell 150 to the positive terminal of the next cell 150; and
an electronic switch SP, which can be activated for coupling the negative terminal of the cell 150 to the negative terminal of the next cell 150.

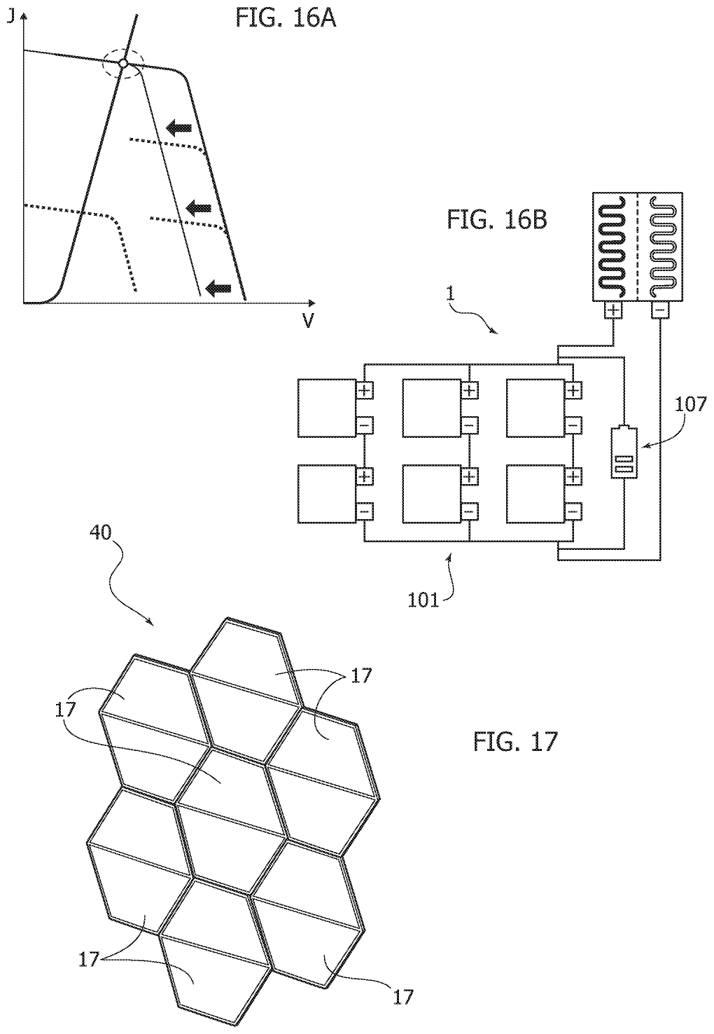

One or more embodiments, as described previously, may comprise an energy-buffer system 107. As exemplified in FIGS. 16A and 16B, in the case where, by modifying the electrical series/parallel connections within the photovoltaic system 101, it is not however possible to get the PV-EC system to work at the elbow of the photovoltaic curve, the voltage surplus may be used for charging the buffer system 107. The buffer system 107 may then be selectively coupled (for example, via one or more respective electronic switches) to the output of the photovoltaic system 101.

FIG. 17 represents an example of an apparatus 40 comprising a plurality of electrochemical cells 17 assembled in a chequerboard or hexagonal-mosaic configuration.

One or more embodiments of the present invention consequently provide one or more of the following advantages:
the possibility of producing hydrogen via electrolysis of water, directly exploiting solar energy, without any need to use intermediate buffers (for example, batteries for storing electrical energy) or intensive systems (for example, electrolyzers);
the possibility of producing extensively and in situ (where required), via stand-alone devices, green hydrogen exploiting the combination (for example, the integration) of a photovoltaic system and of a catalytic system;
the possibility of combining in the same reactor the water-splitting reaction, by means of which hydrogen is produced, with reactions other (for example, reactions for valorizing the emissions of carbon dioxide, enabling recycling and re-use of the latter); and
increased flexibility and ease of installation and use of the electrochemical reactor as compared to known reactors.

Consequently, one or more embodiments may provide a solution to two main problems of the energy sector:
the problem of the intermittence of solar radiation, which is solved via a form of storage of the (chemical) energy that is extremely more compact (e.g., up to 200 times more compact) and stable in time as compared to lithium-ion batteries, through the production of green hydrogen; and
the problem of the CO₂ emissions, which is solved via their valorization in exploitable products.

One or more embodiments enable in fact recycling of the CO₂ emissions and production of green hydrogen and/or other by-products (e.g., glycolic acid) via direct and in-situ use of the renewable energy sources (solar energy). This is possible by integrating a system of solar absorption (PV system) with an electrochemical (EC) system in a single system. This solution provides flexibility of use, ease of installation and use, and moreover enables coupling the water-splitting reaction (for the production of hydrogen) with other reactions, for example the reactions for valorizing the emissions of carbon dioxide or glycerol (waste product of the biogas), thus also enabling recycling and re-use of these products.

It will be noted that, even though in the present description reference is made in a number of points to the possibility of using the electrochemical cell according to the invention in order to produce hydrogen via electrolysis of water, optionally implementing also a reaction of reduction of CO₂ (for example, with production of syngas), one or more embodiments may provide an electrochemical reactor suited for carrying out reduction-oxidation reactions of various types, activated exclusively by solar energy collected by the cell itself, in a continuous and stable way and hence suited for use in contexts of industrial production.

Without prejudice to the underlying principles, the details and the embodiments may vary even considerably with respect to what has been described herein merely by way of example, without thereby departing from the extent of protection.

The extent of protection is defined by the annexed claims.

1. An electrochemical cell comprising:
a first reaction chamber comprising a first electrode;
a second reaction chamber comprising a second electrode;
a membrane-electrode assembly arranged between the first reaction chamber and the second reaction chamber, said membrane-electrode assembly comprising an ion-exchange membrane; and
a photovoltaic system configured to absorb solar energy and produce an output voltage between a first output terminal and a second output terminal of the photovoltaic system, wherein the first output terminal of the photovoltaic system is selectively couplable to said first electrode and said second output terminal of the photovoltaic system is selectively couplable to said second electrode, and wherein a ratio between a photosensitive area of said photovoltaic system and an active area of said first electrode and second electrode is less than or equal to fifty,
wherein the photovoltaic system comprises a plurality of photovoltaic cells selectively couplable between said first output terminal and said second output terminal of the photovoltaic system in a series configuration, a parallel configuration, or one or more mixed series/parallel configurations, and
wherein the electrochemical cell comprises an electronic control unit configured to couple said photovoltaic cells in a configuration selected from among said configurations as a function of one or more user-settable parameters, and/or one or more signals received from an external control unit, and/or one or more signals received from one or more sensors included in the electrochemical cell.

2. The electrochemical cell of claim 1, wherein said one or more sensors included in the electrochemical cell comprise at least one of:
a current sensor configured to sense a current that flows in said first electrode and said second electrode, and
a voltage sensor configured to sense a voltage applied between said first electrode and said second electrode.

3. The electrochemical cell of claim 1, wherein the ratio between the photosensitive area of said photovoltaic system and the active area of said first electrode and second electrode is less than or equal to ten.

4. The electrochemical cell of claim 1, wherein the photosensitive area of said photovoltaic system, the active area of said first electrode, and the active area of said second electrode are in the range from 25 cm² to 1 m².

5. The electrochemical cell of claim 1, wherein said first electrode comprises a first electrically conductive plate, and said first reaction chamber consists of at least one respective flow channel engraved on a surface of the first electrically conductive plate that faces said ion-exchange membrane, and wherein said second electrode comprises a second electrically conductive plate, and said second reaction chamber consists of at least one respective flow channel engraved on a surface of the second electrically conductive plate that faces said ion-exchange membrane in a position corresponding to said flow channel engraved on the surface of said first electrically conductive plate, whereby a first reaction fluid introduced into said first reaction chamber and a second reaction fluid introduced into said second reaction chamber flow on two opposite sides of the ion-exchange membrane at corresponding positions.

6. The electrochemical cell of claim 1, further comprising a first gas-diffusion layer arranged between said first electrode and said ion-exchange membrane, and a second gas-diffusion layer arranged between said second electrode and said ion-exchange membrane.

7. The electrochemical cell of claim 1, further comprising an accumulator of electrical energy, wherein said electronic control unit is configured to
couple said accumulator of electrical energy to said photovoltaic system to store electrical energy produced in excess by said photovoltaic system in response to said photovoltaic system supplying an output voltage higher than a first voltage threshold.

8. The electrochemical cell of claim 1, further comprising a first pump controlled by said electronic control unit to adjust a flow of a first reaction fluid introduced into said first reaction chamber and a second pump controlled by said electronic control unit to adjust a flow of a second reaction fluid introduced into said second reaction chamber.

9. The electrochemical cell of claim 8, further comprising one or more pressure sensors and/or one or more flow-rate sensors for detecting one or more parameters indicative of said flows of said first reaction fluid and said second reaction fluid, wherein said electronic control unit is configured to control said first pump and said second pump to adjust recirculation and introduction of said first and second reaction fluids as a function of said one or more detected parameters indicative of said flows.

10. The electrochemical cell of claim 1, further comprising:
a first split valve arranged in an outlet duct from said first reaction chamber; and
a second split valve arranged in an outlet duct from said second reaction chamber,
wherein said first split valve is configured to split a first gaseous product of reaction from a first reaction fluid introduced into said first reaction chamber, and to convey said first gaseous product of reaction towards a first storage reservoir and re-introduce said first reaction fluid into said first reaction chamber, and
wherein said second split valve is configured to split a second gaseous product of reaction from a second reaction fluid introduced into said second reaction chamber, and to convey said second gaseous product of reaction towards a second storage reservoir and re-introduce said second reaction fluid into said second reaction chamber.

11. An apparatus comprising:
a plurality of electrochemical cells, each electrochemical cell of the plurality of electrochemical cells comprising:
a first reaction chamber comprising a first electrode;
a second reaction chamber comprising a second electrode;
a membrane-electrode assembly arranged between the first reaction chamber and the second reaction chamber, said membrane-electrode assembly comprising an ion-exchange membrane; and
a photovoltaic system configured to absorb solar energy and produce an output voltage between a first output terminal and a second output terminal of the photovoltaic system, wherein the first output terminal of the photovoltaic system is selectively couplable to said first electrode and said second output terminal of the photovoltaic system is selectively couplable to said second electrode, and wherein a ratio between a photosensitive area of said photovoltaic system and an active area of said first electrode and second electrode is less than or equal to fifty,
wherein the photovoltaic system comprises a plurality of photovoltaic cells selectively couplable between said first output terminal and said second output terminal of the photovoltaic system in a series configuration, a parallel configuration, or one or more mixed series/parallel configurations, and
wherein the electrochemical cell comprises an electronic control unit configured to couple said photovoltaic cells in a configuration selected from among said configurations as a function of one or more user-settable parameters, and/or one or more signals received from an external control unit, and/or one or more signals received from one or more sensors included in the electrochemical cell;
a first storage reservoir in fluid communication with the first reaction chambers of said electrochemical cells for receiving a first gaseous product of reaction;
a second storage reservoir in fluid communication with the second reaction chambers of said electrochemical cells for receiving a second gaseous product of reaction;
an apparatus electronic control unit;
a first distribution circuit for a first reaction fluid in fluid communication with the first reaction chambers of said electrochemical cells, the first distribution circuit comprising a first apparatus pump; and
a second distribution circuit for a second reaction fluid in fluid communication with the second reaction chambers of said electrochemical cells, the second distribution circuit comprising a second apparatus pump;
wherein said apparatus electronic control unit is configured to control said first apparatus pump to adjust a flow of said first reaction fluid introduced into said first distribution circuit and to control said second apparatus pump to adjust a flow of said second reaction fluid introduced into said second distribution circuit.

12. The apparatus of claim 11, wherein said apparatus electronic control unit is configured to exchange control signals and/or feedback signals with said electronic control units of said electrochemical cells.

13. The electrochemical cell of claim 1, wherein the ratio between the photosensitive area of said photovoltaic system and the active area of said first electrode and second electrode is less than or equal to five.

14. The electrochemical cell of claim 1, wherein the ratio between the photosensitive area of said photovoltaic system and the active area of said first electrode and second electrode is equal to one.

15. The electrochemical cell of claim 1, wherein the photosensitive area of said photovoltaic system, the active area of said first electrode, and the active area of said second electrode range from 50 cm² to 25 dm².

16. The electrochemical cell of claim 1, wherein the photosensitive area of said photovoltaic system, the active area of said first electrode, and the active area of said second electrode are equal to 100 cm².

17. The electrochemical cell of claim 7, wherein said electronic control unit is configured to couple said accumulator of electrical energy to said first electrode and said second electrode to supply thereto the electrical energy stored in said accumulator of electrical energy in response to said photovoltaic system supplying an output voltage lower than a second voltage threshold.

18. The electrochemical cell of claim 7, wherein said electronic control unit is configured to couple said accumulator of electrical energy to said first electrode and said second electrode to supply thereto a minimum supply voltage during an inactivity phase of said photovoltaic system.

19. The electrochemical cell of claim 7, wherein said electronic control unit is configured to couple said accumulator of electrical energy to said first electrode and said second electrode to supply thereto the electrical energy stored in said accumulator of electrical energy in response to an output voltage of said photovoltaic system undergoing an oscillation, an interruption, or a sudden variation.

20. The electrochemical cell of claim 7, wherein said electronic control unit is configured to couple said accumulator of electrical energy to said electronic control unit for electrically supplying said electronic control unit.
